(19) United States
(12) Patent Application Publication
(10) Pub. No.: US 2004/0018863 A1
(43) Pub. Date: Jan. 29, 2004

(54) Personalization of mobile electronic devices using smart accessory covers

(76) Inventors: G. Eric Engstrom, Kirkland, WA (US); Peter Zatloukal, Kirkland, WA (US); Tyrol R. Graham, Seattle, WA (US); Joshua R. Buesseler, Mercer Island, WA (US); William K. Ford, Bothell, WA (US)

Correspondence Address: SCHWABE, WILLIAMSON & WYATT, P.C., PACWEST CENTER, SUITES 1600-1900, 1211 SW FIFTH AVENUE, PORTLAND, OR, 97204, US

(21) Appl. No.: 10/428,815

(22) Filed: May 2, 2003

Related U.S. Application Data
(63) Continuation-in-part of application No. 09/933,858, filed on Aug. 20, 2001.
(63) Continuation-in-part of application No. 10/087,098, filed on Mar. 1, 2002.
(63) Continuation-in-part of application No. 09/932,154, filed on Aug. 17, 2001.
(63) Continuation-in-part of application No. 10/000,170, filed on Nov. 30, 2001.
(63) Continuation-in-part of application No. 10/301,431, filed on Nov. 20, 2002.
(63) Continuation-in-part of application No. 10/346,071, filed on Jan. 17, 2003.
(63) Continuation-in-part of application No. 10/365,620, filed on Feb. 13, 2003.
(60) Provisional application No. 60/306,326, filed on Jul. 17, 2001.
(60) Provisional application No. 60/292,123, filed on May 17, 2001.
(60) Provisional application No. 60/418,925, filed on Oct. 15, 2002.

(51) Int. Cl. H04B 1/38

(52) U.S. Cl. 455/575.8; 455/575.1; 455/90.3

(57) ABSTRACT

A smart accessory cover adapted for adornment by a mobile electronic device such as a mobile phone, a personal digital assistant, a palm sized personal computer, a media player or a game console is provided. The accessory cover includes physical design to convey a theme, and an embedded electronic component having data and/or programming instructions to personalize the functionalities of the mobile electronic device in accordance with the theme. In various embodiments, the theme may be a celebrity singer theme, a celebrity sport figure theme, or other themes.

### RELATED APPLICATION

This application is a continuation-in-part application to:

(a) U.S. patent application Ser. No. 09/933,858, filed Aug. 20, 2001, entitled “Interchangeable Cover For a Mobile Communication Device”;

(b) U.S. patent application Ser. No. 10/087,098, filed Mar. 1, 2002, entitled “PERSONALIZING ELECTRONIC DEVICES AND SMART COVERING”, which itself claims priority to its provisional filing No. 60/306,326, filed on Jul. 17, 2001;

(c) U.S. patent application Ser. No. 09/932,154, filed Aug. 17, 2001, entitled “MOBILE ELECTRONIC DEVICE AND COVERING FOR SIMILAR DEVICES WITH ORNAMENT ATTACHMENT MECHANISM”, which itself claims priority to its provisional filing No. 60/292,123, filed on May 17, 2001;

(d) U.S. patent application Ser. No. 10/001,170, filed Nov. 30, 2001, entitled “Avoiding Attachment of Ineligible Smart Interchangeable Cover To An Electronic Device”;

(e) U.S. patent application Ser. No. 10/301,431, filed Nov. 20, 2002, entitled “Adding Control Keys to Mobile Devices Via Smart Interchangeable Cover”, which itself claims priority to its provisional filing No. 60/418,925, filed on Oct. 15, 2002;

(f) U.S. patent application Ser. No. 10/346,071, filed Jan. 16, 2003, entitled “INTERCHANGEABLE COVERING ADDITIONS TO A MOBILE COMMUNICATION DEVICE FOR DISPLAY AND KEY REORIENTATION”; and

(g) U.S. patent application Ser. No. 10/365,620, filed Feb. 14, 2003, entitled “PERSONALIZING ELECTRONIC DEVICE AND SMART COVERING”.

This continuation-in-part application claims priority to the above enumerated applications. The specifications of the above enumerated applications are hereby fully incorporated by reference, to the extent the specifications are consistent or complementary to the specification of this continuation-in-part application.

### FIELD OF INVENTION

The invention relates to the field of electronic devices. More specifically, the invention relates to the personalization of mobile electronic devices using smart accessory covers.

### BACKGROUND OF THE INVENTION

With the proliferation of electronic devices, especially mobile electronic devices, such as, mobile phones, hand-held personal computers (PC), and so forth, these devices have gained the status of personal appliances to a person. As a result, increasingly, users desire to personalize these devices. For example, in addition to a wide variety of body casing colors, interchangeable faceplates of various colors and artistic designs are available for a variety of mobile phones to allow the users to have even greater choices providing different physical appearances to their own devices. Additionally, a variety of non-standard screen-savers and ring tones can be downloaded into the devices to further personalize the devices. Similarly, hand-held personal computers and personal digital assistants also come in various colors, with various screen savers and wallpapers.

These approaches to personalization suffer from a number of disadvantages. First, they are disjoint. Typically, a user may go to a mall or an online e-commerce site to shop and purchase, e.g. a faceplate with design and/or color that is of interest to the user. Then, the user may go online to web sites to search and look for a custom ring tone or a screen saver of interest to the user. It is the user's responsibility to choose and combine the appropriate hardware, i.e. faceplate design/color, with the software behavior, i.e. custom ring tone etc. to create a total personality. The process is cumbersome for many users, especially for the more novice users, as the proliferation of mobile electronic devices reaches more and more users. Moreover, the approaches do not facilitate quick and timely changes to the personality to be taken on by the mobile electronic devices. These shortcomings apply equally to personalization of other electronic devices, such as game consoles.

Thus, an improved approach to provide users with better personalization experience is desired.

### BRIEF DESCRIPTION OF DRAWINGS

The invention is illustrated by way of example and not by way of limitation in the figures of the accompanying drawings, in which like references indicate similar elements and in which:

FIGS. 1A-1E comprise various views of a smart accessory cover for a mobile phone in accordance with a first embodiment;

FIGS. 2A-2B and 3 illustrate views of a mobile phone adorned with the smart accessory cover of FIGS. 1A-1E;

FIGS. 4A-4B and 5 depict various views of a smart accessory cover in accordance with a second embodiment;

FIGS. 6A and 6B are isometric views used to illustrate how a mobile phone is adorned with a smart accessory cover of FIGS. 1A-1E or FIGS. 4A-4B and 5;

FIGS. 7A and 7B are isometric views of a mobile phone suitable for adorning the smart accessory covers of FIGS. 1A-1E or FIGS. 4A-4B and 5;

FIGS. 8A and 8B are isometric views of a variant of the smart accessory cover of FIGS. 1A-1E or FIGS. 4A-4B and 5 that uses a plurality of latches to assist a mobile phone in adorning the smart accessory cover;

FIGS. 9A and 9B are isometric views illustrating another variant of the smart accessory cover of FIGS. 1A-1E or FIGS. 4A-4B and 5, in which an inwardly extending protrusion is defined in the smart accessory cover;

FIG. 10 is an isometric view of another variant of the smart accessory cover of FIGS. 1A-1E or FIGS. 4A-4B and 5, in which an opening and optional lens are included in a smart accessory cover to enable a user to view a display on the mobile phone adorning the smart accessory cover;

FIG. 11 illustrates an architectural view of the internal electronic components of an exemplary mobile phone, suitable for practicing the present invention;

FIGS. 12A & 12B illustrate the operational flow of the relevant aspects of the operating logic of a mobile phone, suitable for practicing the present invention;

FIGS. 13A-13E illustrate an example application of the present invention, personalizing a mobile phone to a singer celebrity theme; and

FIGS. 14A-14F illustrate another example application of the present invention, personalizing a mobile phone to a sport celebrity theme.

FIG. 15 is an isometric view of an embodiment of the invention in which the smart accessory cover is adapted to be adorned by a PDA device or a pocket PC; and

FIG. 16 is an isometric view of an embodiment of the invention in which the smart accessory cover is adapted to be adorned by a two-way wireless pager.

### DETAILED DESCRIPTION OF THE INVENTION

For ease of understanding, the present invention will be primarily described in the context of wireless mobile phones. However, it is anticipated that the present invention may be practiced on a wide range of other mobile electronic devices, including but are not limited to wireless pagers, game consoles, media players, and other devices of the like. Accordingly, references to wireless mobile phones in the description to follow are merely illustrative, and are not to be read as limitations to the claims.

In the following description, various aspects of the invention will be described. However, it will be apparent to those skilled in the art that the invention may be practiced with only some or all aspects of the invention. For purposes of explanation, specific numbers, materials and configurations are set forth in order to provide a thorough understanding of the invention. However, it will also be apparent to one skilled in the art that the invention may be practiced without the specific details. In other instances, well-known features are omitted or simplified in order not to obscure the invention.

Parts of the description will be presented in terms commonly employed by those skilled in the art to convey the substance of their work to others skilled in the art. In particular, the terms “wireless mobile phone” and “mobile phone” as used herein (the specification as well as the claims) refer to the class of telephony devices equipped to make and receive calls wirelessly, notwithstanding movement, as long as the device is within the communication reach of a service or base station of a wireless network service provider. Unless specifically excluded, these terms are to include the analog subclass as well as the digital subclass (of all signaling protocols).

Terms such as instructions, data, and the like, refer to quantities that may take the form of electrical, magnetic, or optical signals. These signals may be stored, transferred, combined, and otherwise manipulated through mechanical, electrical and/or optical components of the devices.

Various operations will be described as multiple discrete steps in turn, in a manner that is most helpful in understanding the invention, however, the order of description should not be construed as to imply that these operations are necessarily order dependent. In particular, these operations need not be performed in the order of presentation.

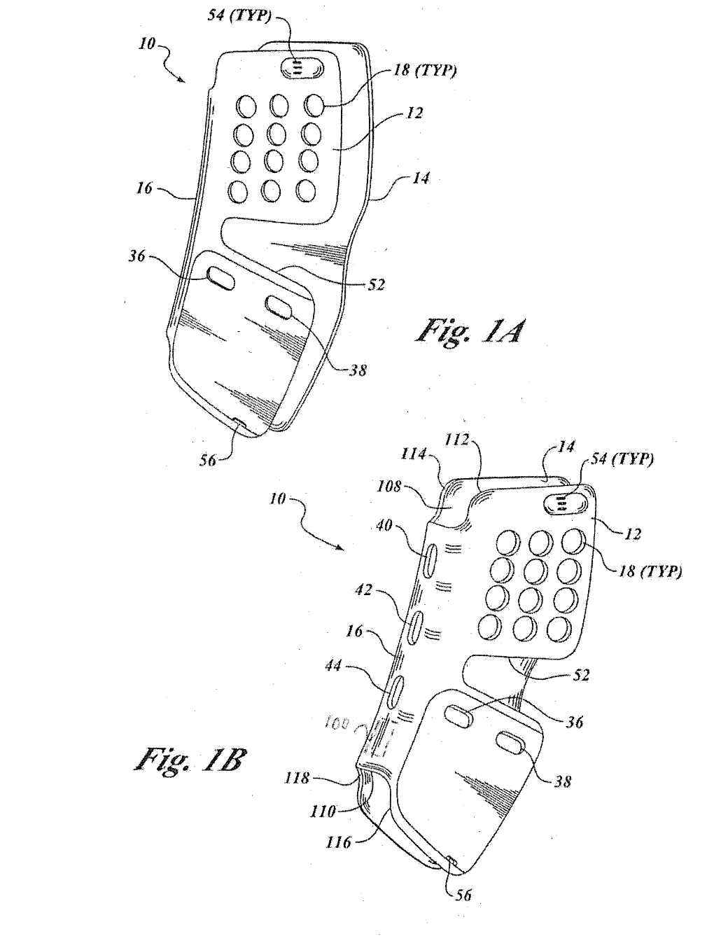

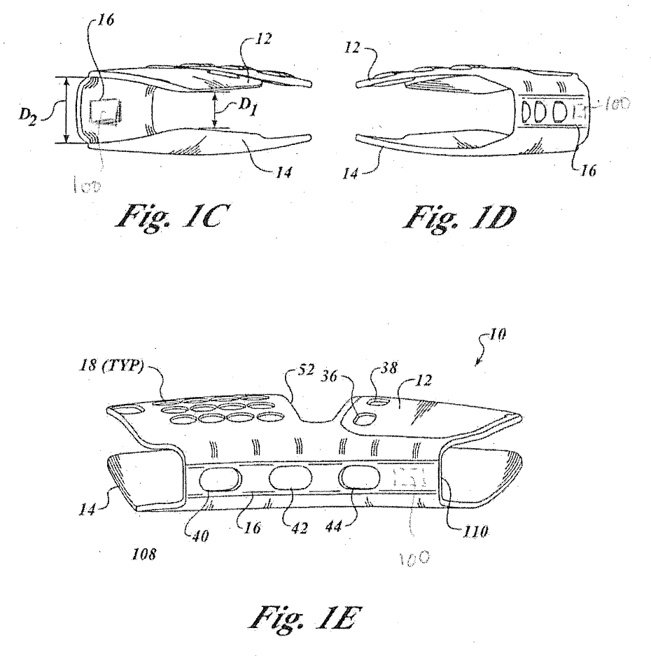

Referring now to FIGS. 1A-E, a smart accessory cover 10 in accordance with a first embodiment of the invention is shown. Smart accessory cover 10 incorporated with the teachings of the present invention is designed to enable a complementarily shaped and dimensioned mobile phone to be personalized in an improved and more user friendly manner not available under the prior art.

As will be described in more detail below, in various embodiments, smart accessory cover 10 may include physical designs (typically thematic) depicted on its exterior surfaces, and complementary instructions and/or data disposed in integrated electronic components, to enable a mobile phone adorning smart accessory cover 10 to be personalized physically as well as behaviorally.

For the present application, physical personalization refers to the outward appearance of the mobile phone, e.g. its color, graphics depicted on the exterior surfaces, and so forth. Whereas behavioral personalization refers to the customization of the functionalities of the mobile phone, e.g. modification of its ring tone, wall paper, screen savers, and so forth.

As will be also further described in detail below, smart accessory cover 10 is an “accessory” cover designed to be adorned by a targeted mobile phone. Smart accessory cover 10 is designed to personalize the adorning mobile phone as an “accessory”, as jewelries, scarf, and so forth designed to be adorned to personalize clothing for style and look, and insulation jackets, sleeves, and so forth designed to be adorned to enhance the insulation attribute of a hot beverage container. As jewelries and scarf are entities separate and distinct from the underlying clothing, insulation jackets and sleeves are entities separate and distinct from the underlying hot beverage container, so is smart accessory cover 10, an entity separate and distinct from the targeted mobile phones.

Smart accessory cover 10 is not a required element to complete the underlying mobile phone. As clothing may be worn without accessory jewelries or scarf, or a hot beverage container may be used without an additional insulation jacket/sleeve, in like manner, under the present invention, a targeted mobile phone may be used without any smart accessory cover 10. In particular, smart accessory cover 10 is not an element of the housing of a targeted mobile phone.

Accordingly, smart accessory cover 10 may also be referred to as smart accessory jacket, smart accessory sleeve or other descriptive terms of the like.

Further, the term “cover” as used herein refers to a part that inherently includes multiple surfaces that substantively cover at least multiple ones of the exterior surfaces of the target mobile device, where the exterior surfaces are inherently disposed in different geometric planes. Accordingly, while a “cover” may come in many variants, as illustrated by the description to follow, a “card” like part, i.e. a part having the form factor of a “credit card”, a PCMCIA card, a PC card, a Compact Flash card and so forth, a “faceplate” or a “back plate” is not a “cover”, for the purpose of the present application. A “card” or “plate” like part, for the purpose of the present application, by definition, is considered to occupy only one geometric plane. To the extent, a “plate” covers any geometric planes orthogonal to the main plane, the coverage is typically insubstantial or deminimus. [PCMCIA=Personal Computer Memory Card International Association]

For ease of understanding, hereinafter instructions and/or data shall simply be referred to as data. Accordingly, usage of the term “data”, including in the claims, unless the context clearly denote otherwise, may include instructions as well as data.

Continuing to refer to FIGS. 1A-1E, for the embodiment, smart accessory cover 10 comprises a resilient semi-rigid shell having a front face 12 and a back face 14 commonly connected to a side portion 16. As illustrated, smart accessory cover 10 has a substantially “U”-shaped profile. As used herein, substantially “U”-shaped means there are two extending portions connected to a base portion that is substantially perpendicular to the extending portions, and wherein there is a bevel or radius where each extending portion joins the base portion.

In one embodiment, the extending portions of the “U” are rotated toward each other such that a distance D1 between the end portions of the “U” is less than a distance D2 at the root of the “U”.

As explained in further detail below, this configuration is adapted to enable smart accessory cover 10 to clasp around a complementary mobile phone, which in one embodiment, has a substantially trapezoidal profile.

Smart accessory cover 10 includes in particular, electronic component 100 incorporated with data to personalize the functionalities of a targeted mobile phone, to be described more fully below. In various embodiments, electronic component 100 may be a memory, such as electrically erasable programmable read only embedded memory (EEPROM), compact flash, a smart card, a processor or controller having embedded memory, or a system-on-chip having a processor, embedded memory, and other function blocks.

As illustrated, for the embodiment, electronic component 100 is disposed in the inside surface of side surface 16, designed to mate with a “connector” complementarily disposed on a targeted mobile phone. The “connector” may be any one of a number of coupling interface known in the art or to be designed, including but are not limited to parallel or serial interfaces.

In alternate embodiments, the present invention may be practiced employing more than one electronic component, and/or more than one complementary connectors disposed to the targeted mobile phone. Further, the one or more electronic components may be disposed in other locations and/or surfaces of smart accessory cover 10.

Mechanically, for the embodiment, smart accessory cover 10 includes a plurality of openings 18 through which respective keypad buttons on a target mobile phone may pass, upon adornment of the smart accessory cover by the mobile phone.

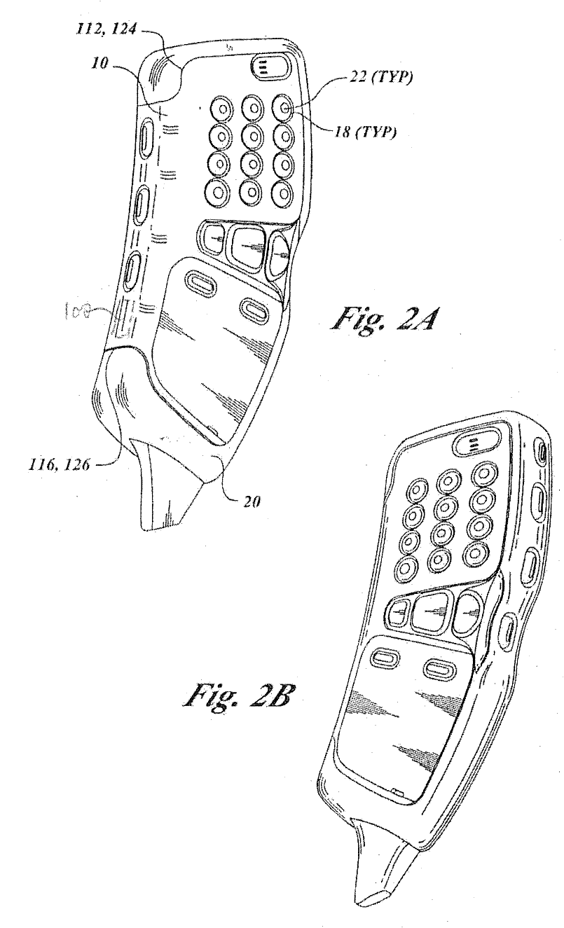

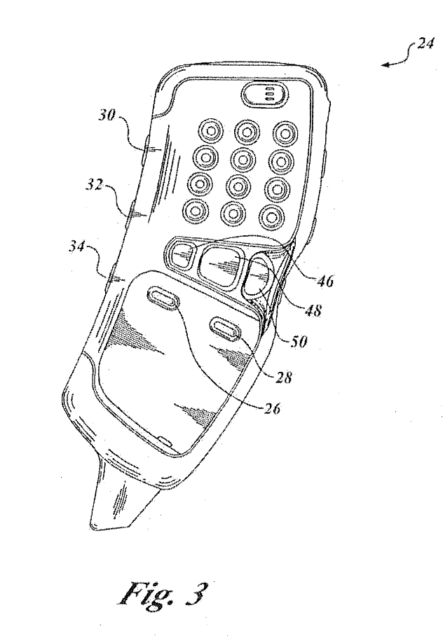

For example, a configuration wherein a smart accessory cover 10 is adorned by a mobile phone 20 including a plurality of keypad buttons 22 is shown in FIGS. 2A and 2B.

Openings 18 enable a user to activate keypad buttons 22 of the mobile phone 20, even after mobile phone 20 has adorned smart accessory cover 10.

In some configurations, the mobile phone adorning the smart accessory cover may include various input buttons in addition to keypad buttons. For example, a mobile phone 24 depicted in FIG. 3 adorning a smart accessory cover 10 includes buttons 26 and 28 on its face, and side input buttons 30, 32, and 34 on its side.

Accordingly, smart accessory cover 10 further includes slots 36 and 38 defined in front face 12, and slots 40, 42 and 44 defined in side portion 16.

Mobile phone 24 also may include additional buttons, including buttons 46, 48 and 50, disposed at a mid-portion of its front surface.

In order to accommodate access to these buttons, smart accessory cover 10 may further include a radiused “V”-shaped cutout 52.

As depicted in FIGS. 1A and 1B, for the embodiment, smart accessory cover 10 also includes one or more speaker slots 54 through which audible signals produced by the mobile phone's speaker may pass, and a microphone slot 56 through which a user's voice may be detected by the mobile phone's microphone.

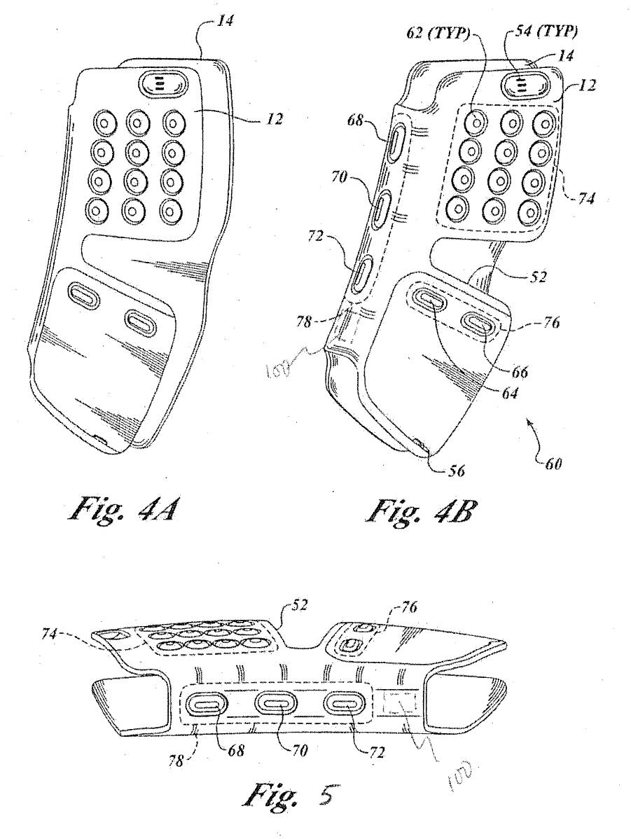

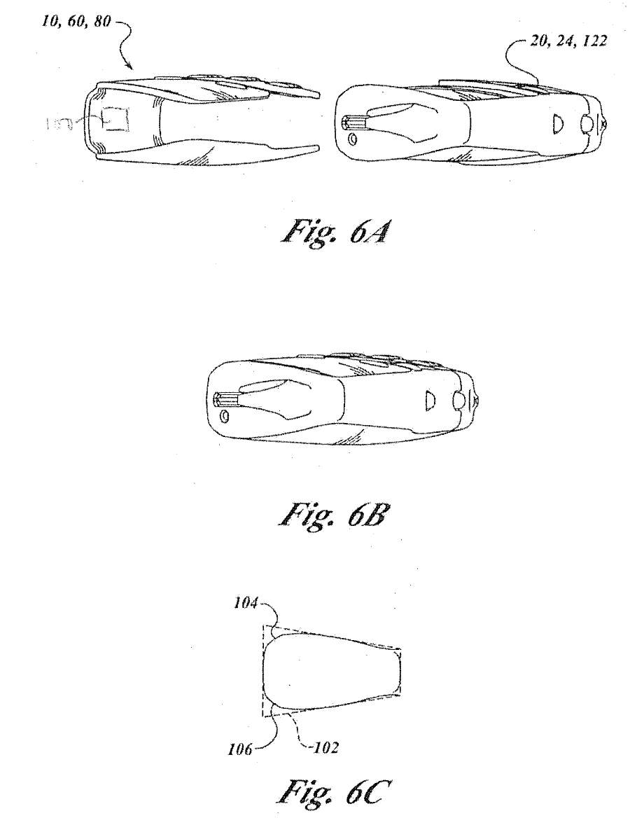

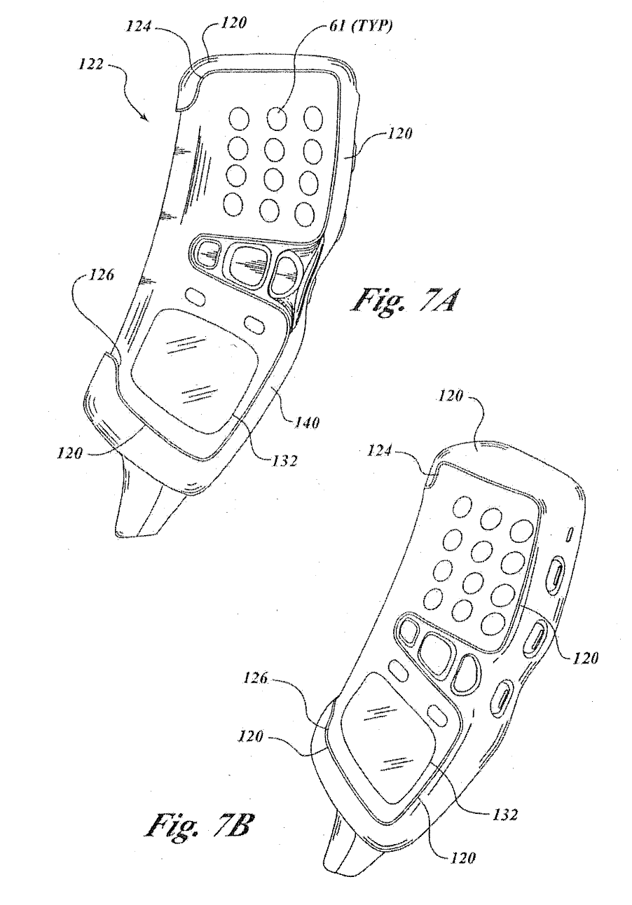

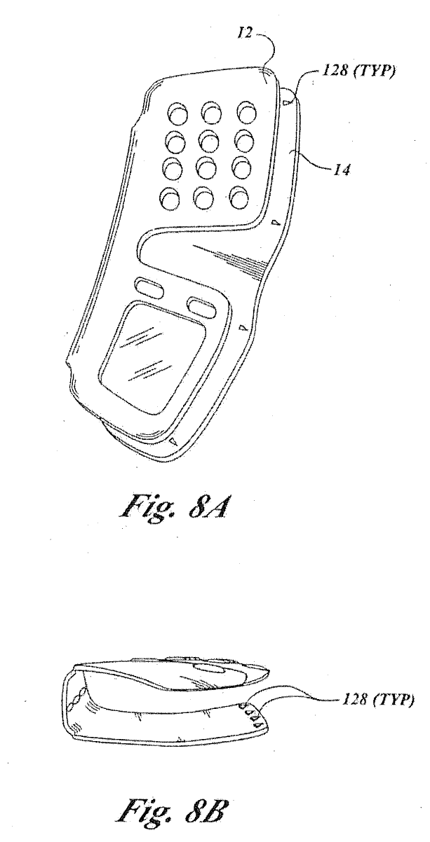

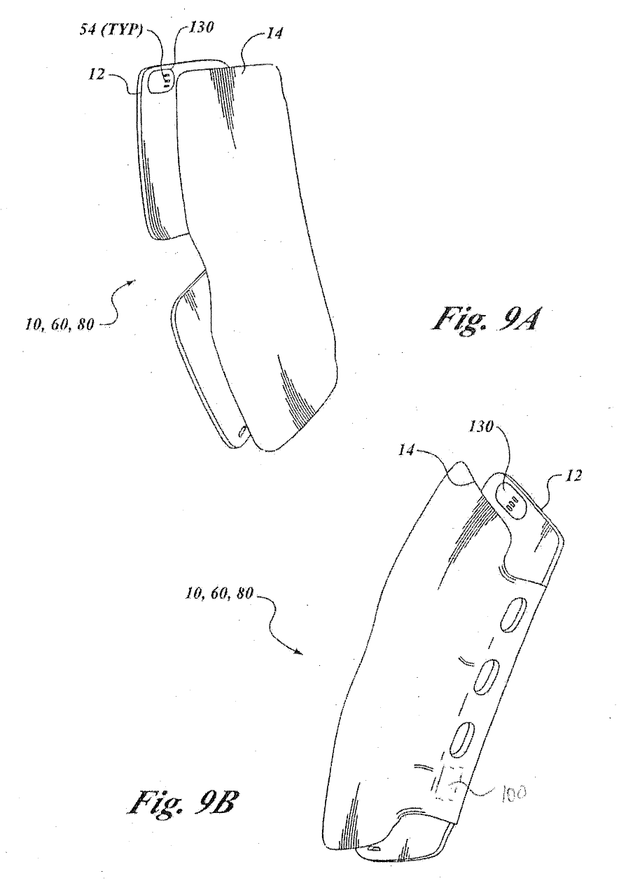

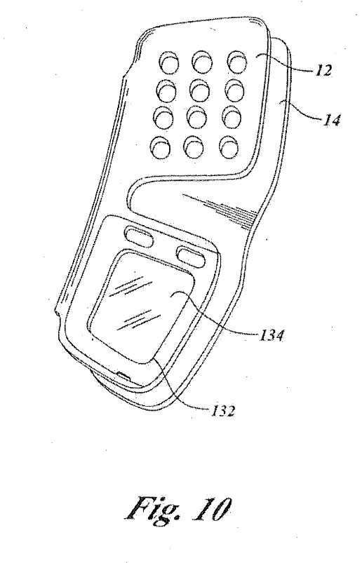

FIGS. 4A-B and 5 illustrate a smart accessory cover 60 in accordance with a second embodiment of the invention. In general, smart accessory cover 60 is substantially similar in configuration to smart accessory cover 10, except that smart accessory cover 60 includes “dumb” buttons that enable corresponding buttons built into the mobile phone (e.g., buttons 61 shown in FIG. 7A) to be actuated via a user pressing on the dumb buttons. Accordingly, like-numbered components in both sets of figures perform substantially the same functions in both configurations.

The dumb buttons include a plurality of dumb keypad buttons 62, dumb input buttons 64 and 66, and side input buttons 68, 70, and 72. In one embodiment, the input buttons comprise a thin membrane sheet in which a plurality of domes are defined, wherein each dome includes a center portion extending below the dome is pressed by a user. These membrane sheets are depicted in FIG. 4B as a membrane sheet 74, a membrane sheet 76, and a membrane sheet 78. The various membrane sheets may be secured to the underside of the smart accessory cover using one of various assembly methods, including but are not limited to the use of appropriate adhesive.

In alternate embodiments, dumb buttons 62 in conjunction with data provided through electronic component 100 may also be employed to reorient the operational relative disposition of the keypad and the display screen of a targeted mobile phone. The elements may be employed to e.g. reorient the target mobile phone from a first operational orientation with the keypad disposed below the display screen to a second operational orientation with the keypad disposed above the display screen, or vice versa.

That is, the keypad of the targeted mobile phone may be labeled for the first operational orientation with the keypad to be disposed below the display screen, and dumb buttons 62 are labeled for the second operational orientation with the keypad to be disposed above the display screen, to support the functional reorientation provided through the data in electronic component 100.

Re-orientation of a mobile device using a smart interchangeable cover is the subject matter of the above identified parent application Ser. No. 10/346,071.

As discussed above, smart accessory covers 10 and 60 are adorned by a mobile phone such that they “clasp” around the profile of the mobile phone. This adornment process is illustrated in FIG. 6A and B. In one embodiment, the profile of the mobile phone (e.g. mobile phone 20) has a radiused trapezoid configuration, as illustrated by a trapezoid 102 in FIG. 6C. The trapeziod-shaped profile also includes radiused corners 104 and 106.

As the leading edges of front face 12 and back face 14 contact radiused corners 104 and 106, respectively, upon adornment of smart accessory cover 10 or 60 by the mobile phone, the leading edges of the front and back faces are caused to be spread apart, enabling smart accessory cover 10 or 60 to be slid over the mobile phone. As the user slides smart accessory cover 10 or 60 further over the mobile phone, the resilient material used for smart accessory cover 10 or 60 causes smart accessory cover 10 or 60 to return to its undeformed configuration, adorning smart accessory cover 10 or 60 to the mobile phone.

In addition to adorning smart accessory cover 10 or 60 to the mobile phone based on the phone's trapezoidal profile, other securing provisions may also be implemented. For example, in one embodiment a pair of “U”-shaped notches 108 and 110 may be defined toward opposing ends of side portion 16, as shown in FIGS. 1B and 1E. Notches 108 and 110 may be configured to engage with portions of peripheral lips defined in the front and back faces of the mobile phone over which smart accessory cover 10 or 60 is to be adorned, such as shown by a peripheral lip 120 defined in the mobile phone, as illustrated in FIGS. 7A and 7B. A substantially similar peripheral lip is formed into the backside of mobile phone 122, as well (not shown).

In one embodiment, notch 108 includes shoulders 112 and 114, while notch 110 includes shoulders 116 and 118. Upon adornment, shoulder 112 engages a radius 124 formed in peripheral lip 120, while shoulder 114 engages a similar radius defined in the peripheral lip on the backside of the phone. Similarly, shoulder 116 engages a radius 126 formed in peripheral lip 120, while shoulder 118 engages a similar radius defined in the peripheral lip on the backside of the mobile phone.

Furthermore, as these radiused portions of smart accessory cover 10 or 60 slide passed their respective shoulders, at least one audible “click” is heard corresponding to a mechanical engagement of the adjacent features.

Details of the adorned configuration are shown in FIGS. 2A and 2B.

A second means for providing assistance in the mobile phone in adorning smart accessory cover 10 or 60 includes a plurality of latches 128, which may be defined in a peripheral portion of the inside surfaces of other or both of front face 12 and back face 14, as shown in FIGS. 8A and 8B.

As shown in the detail of FIG. 8B, in one embodiment each of latches 128 have a triangular profile. A set of adjacent recesses designed to receive the latches are defined in the mobile phone.

Upon adornment, latches 128 latch into respective recesses defined in the mobile phone to assist in adorning smart accessory cover 10 or 60 to the mobile phone.

A third means for providing assistance in adorning smart accessory cover 10 or 60 to the mobile phone comprises the use of one or more inwardly extending protrusions that are define in front face 12 and/or back face 14.

An example protrusion 130 is shown in FIGS. 9A and 9B. A recess having a configuration adapted to receive the protrusion is defined in the mobile phone such that the protrusion(s) fit into (a) respective recess(es) defined in the front and/or back sides of the mobile phones.

As depicted in FIGS. 9a and 9B, in one embodiment speaker slot 54 are defined within a protrusion.

Mobile phone 122 may also include a display 132 in which text and/or graphical data are displayed. For example, display 132 may comprise an LCD. Accordingly, smart accessory cover 10 or 60 may include a cutout 132 configured to provide viewing access to display 132 upon adornment, as shown in FIG. 10.

Optionally, a lens 134, preferably made of a clear, impact resistant material, may be disposed in cutout 132.

Material-wise, smart accessory cover 10 or 60 may be made of any material that provides the desired resilient properties, such as various plastics, including but not limited to, polycarbonate, acrylonitrile butadiene styrene (ABS), or a polycarbonate/ABS blend.

When a plastic is used, smart accessory cover 10 or 60 may be manufactured using well-known plastic manufacturing techniques, such as injection-molding. Electronic component 100 is placed thereon afterwards.

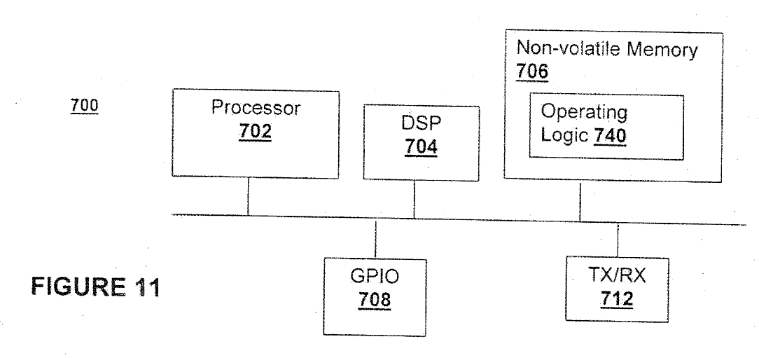

Having now described the mechanical aspects of smart accessory cover 10 and 60, electronic component 100, or more specifically, its contents, and the process of personalizing a targeted mobile phone will now be described. Before doing so, the architecture of an example target mobile phone will first be described referencing FIG. 11. Further, the smart accessory cover of the present invention, and the targeted mobile phones are not limited to the U and trapezoidal shapes nor the uni-body constructions of the above described embodiments. The present invention may be practiced with the smart accessory cover and the targeted mobile phones having other shapes, including but not limited to rectangular, triangular, circular, oval, and so forth, and non-uni body constructions, as in the case of “flip phones” or other multi-portion body constructions.

Referring now to FIG. 11, for the exemplary embodiment, mobile phone 700 includes elements such as processor 702, digital signal processor (DSP) 704, non-volatile embedded memory 706, general-purpose input/output (GPIO) interface 708, and transmit/receive (TX/RX) 712 coupled to each other as shown.

Non-volatile memory 706 is employed to store programming instructions and optionally, working data, including in particular, operating logic 740. Working data may include callee/messaging party or parties (e.g. their phone numbers or IP addresses) with whom user may communicate. Working data may also include personalization data obtained from, or in accordance with the instructions in electronic component 100.

Processor 702, assisted by DSP 704, is employed to operate phone, executing operating logic 740, including personalization instructions obtained from, or in accordance with the instructions in electronic component 100.

GPIO 708 may be employed to interface with a number of input devices, such as keypad, scroll buttons and so forth, including in particular, with electronic components 100 to facilitate transfer of personalization data to and from electronic component 100.

TX/RX 712 may be employed to transmit and receive communication signals for a call and/or a text message. TX/RX 712 may be a radio frequency transceiver, and support one or more of any of the known signaling protocols, including but are not limited to CDMA, TDMA, GSM, and so forth.

Except for their novel usage to facilitate the practice of the present invention, the constitutions of these elements are known, and will not be further described.

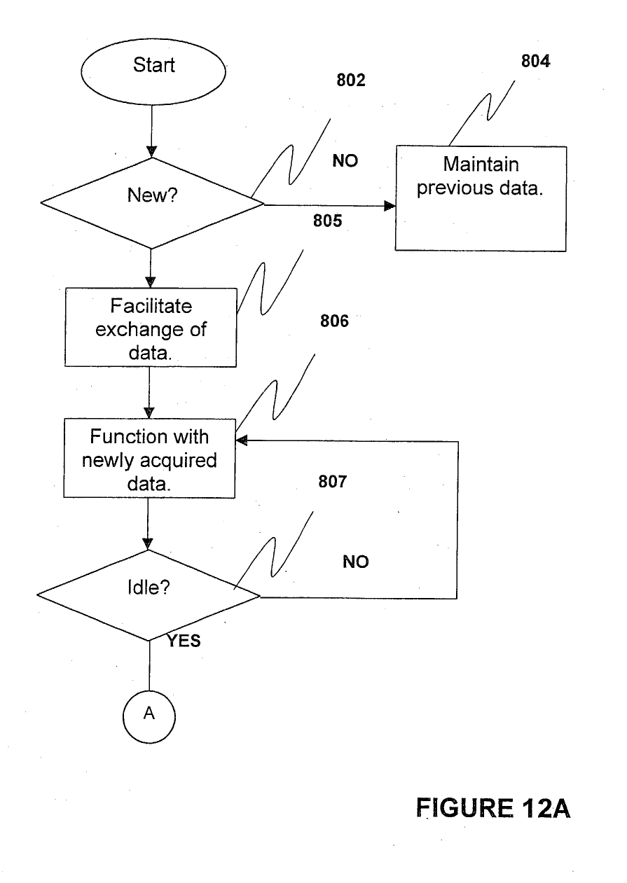

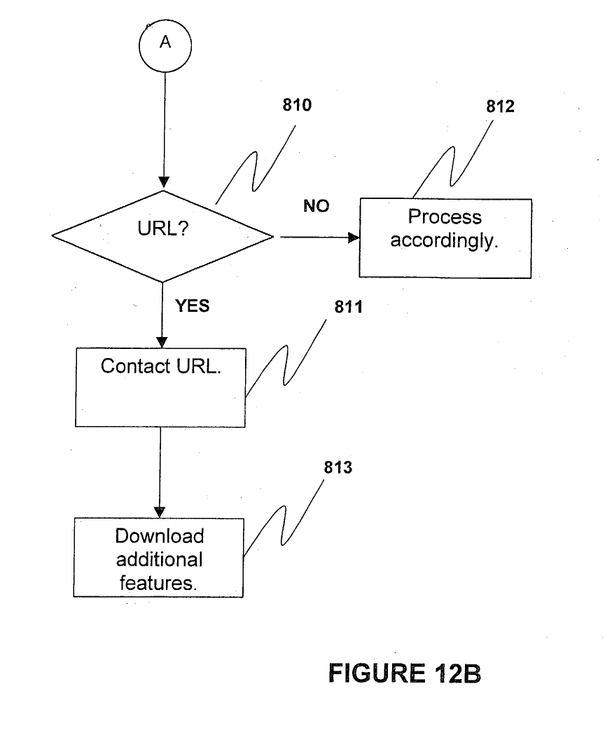

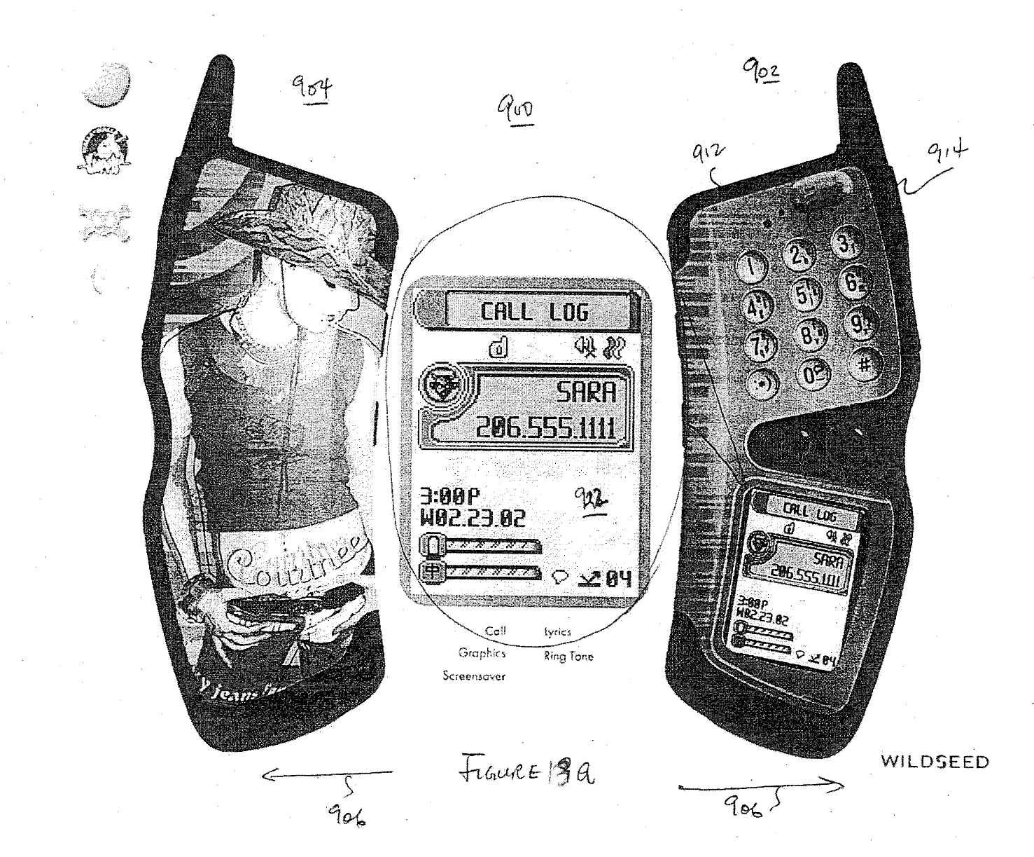

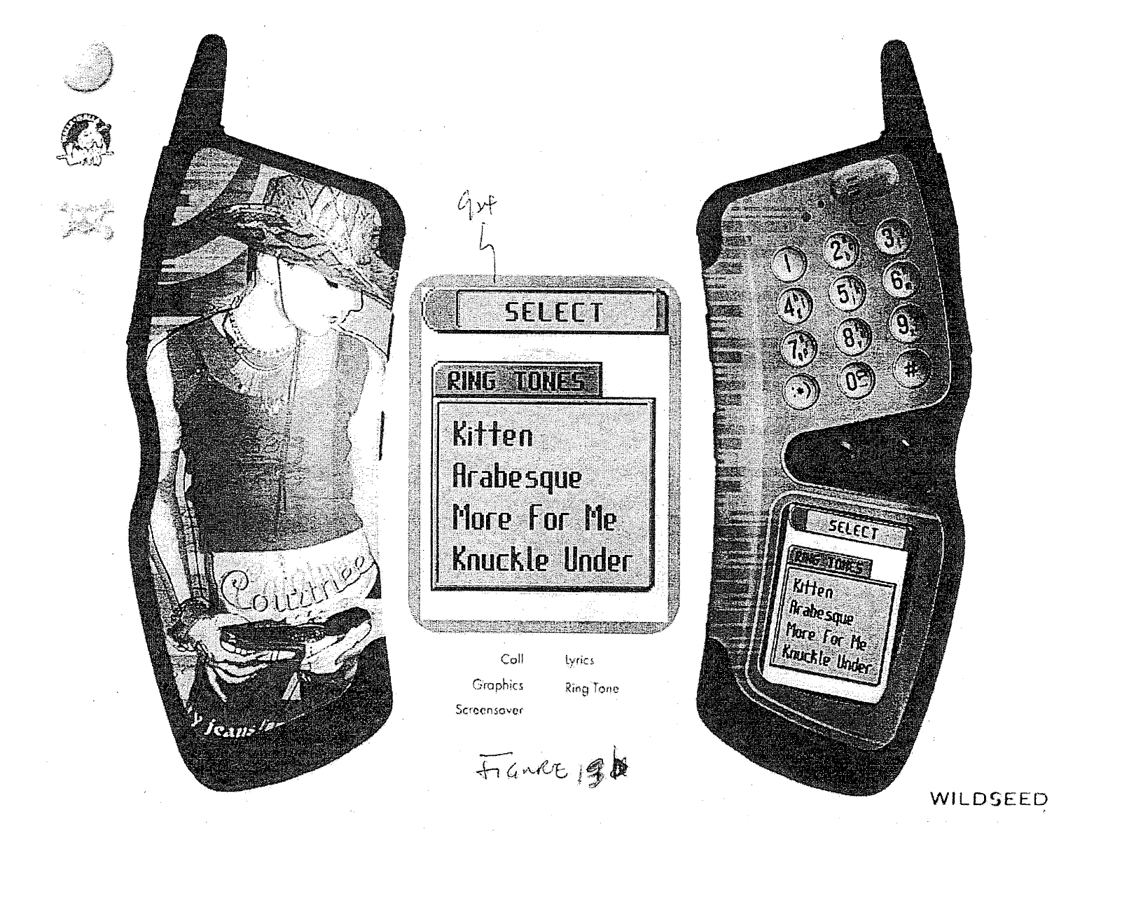

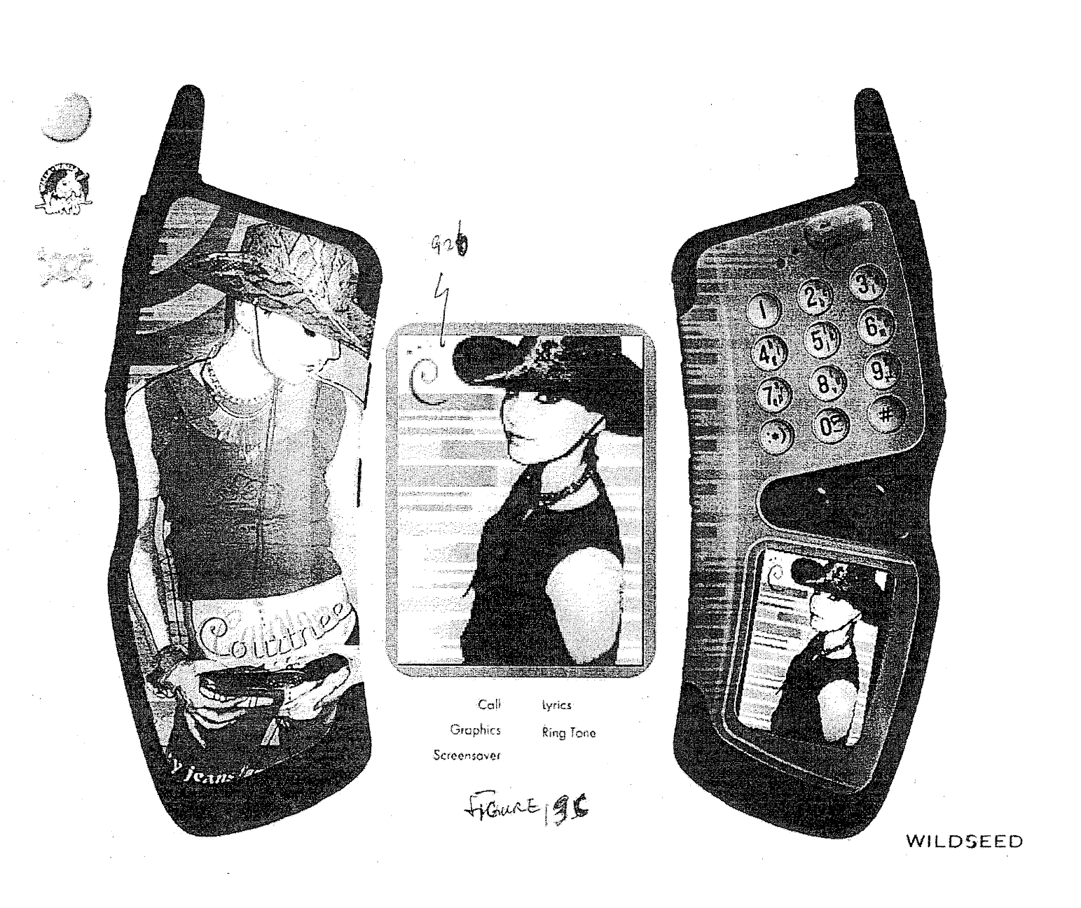

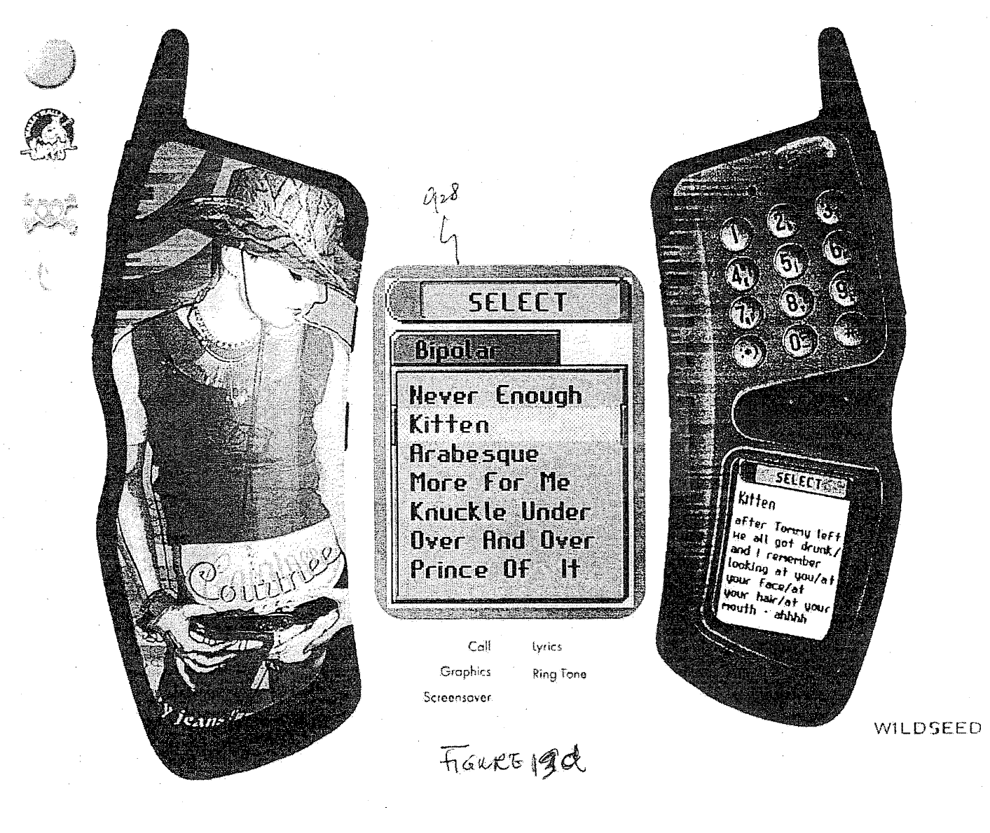

FIGS. 12A & 12B illustrate the operational flow of the relevant aspects of operatic logic 740 of phone 700 to take advantage of the personalization data stored in electronic component 100 of smart accessory cover 10 or 60. Mobile phone 700 is assumed to be adorning smart accessory cover 10 or 60.

Accordingly, as illustrated in FIG. 12A, on initialization, at e.g. power on or reset, the operating logic checks for the presence of a new smart accessory cover 10 or 60 with embedded electronic component 100 having personalizing data, block 802.

Once it is determined that the mobile phone is adorned with a new smart accessory cover 10 or 60, an exchange of data between the new smart accessory cover 10 and 60 and the mobile phone is facilitated, block 805. The exchange of data may be made between e.g. a processor of the mobile phone and embedded electronic component 100 within smart accessory cover 10 or 60.

During this exchange, personalization data complementary to the personalizing theme of the smart accessory cover 10 or 60 may be provided to the mobile phone, block 806. Additionally, during the exchange, a resource server specification may be provided to the mobile phone. This resource server specification may be utilized by the mobile phone to contact the resource server for additional personalization data. The contact may be made immediately or at a later point in time.

In various embodiments, some of the personalization, such as modification of the ring tone or wall paper, may immediately take effect as soon as they are provided to the mobile phone.

In an embodiment where some of the personalization data are obtained at a later deferred point in time, the mobile phone determines appropriate “idle” opportunity, after the immediate personalization has been put into effect, block 807. In various embodiments, the “idle” opportunity may be a predetermined period when the usage of the mobile phone is below a predetermined deminimus threshold.

Back at block 802, if there is no new coupling between the mobile phone and a new smart accessory cover 10 or 60, the mobile phone may maintain a previously installed data complementing a previous personalizing theme until a presence of a new smart accessory cover 10 or 60 with embedded personalizing data is detected, block 804.

Referring now to FIG. 8B, if an “idle” opportunity is available, operating logic 740 may determine if the resource server specification is in the form of an URL, block 810. If the resource server specification is in the form of an URL, the processing of the URL involves contacting a resource server containing data related to personalization, block 811.

Once the resource server is contacted, operating logic 740 may wirelessly access the resource server, and acquire the additional personalization data to further complement the personalizing theme, block 813.

However, if the retrieved data is not in the form of an URL, operating logic 740 may process the non-URL resource specification accordingly to retrieve the additional personalization instruction and/or data, block 812.

Furthermore, if no additional personalization data are available, operating logic 740 may continue to function with only the personalization data acquired from embedded component 100, block 806 (shown in FIG. 12A).

In various embodiments, the personalization data may be provided from electronic component 100 of a smart accessory cover 10 or 60 to an adorning mobile phone in a secured manner, i.e. through a secure content exchange process/protocol. One approach is disclosed in the above identified parent application Ser. No. 10/001,170.

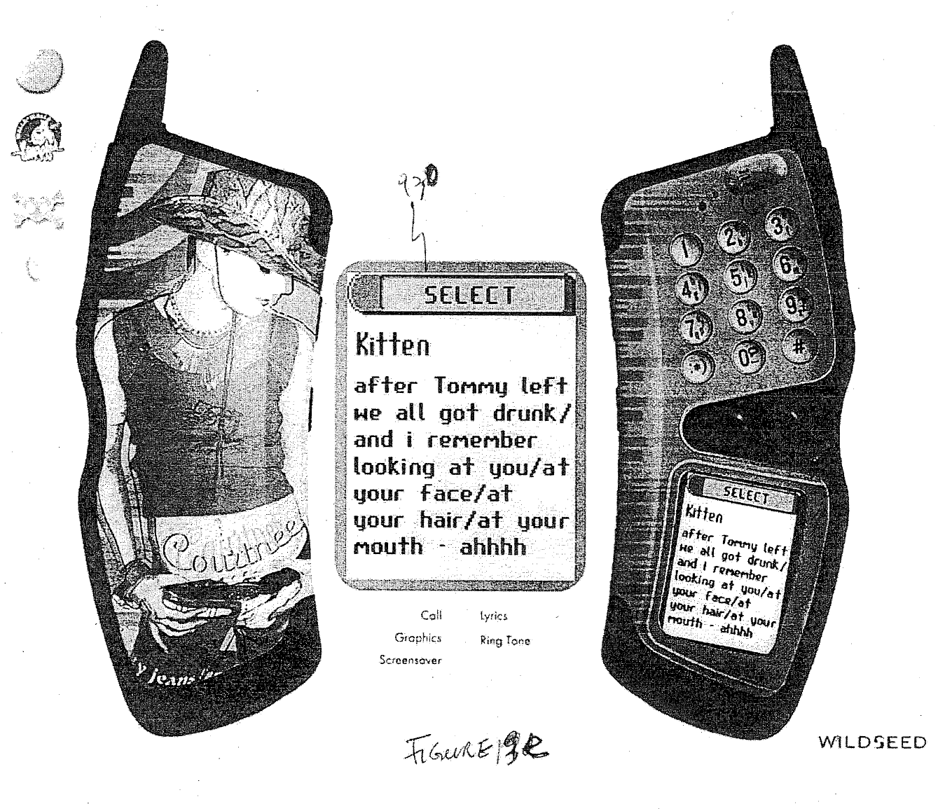

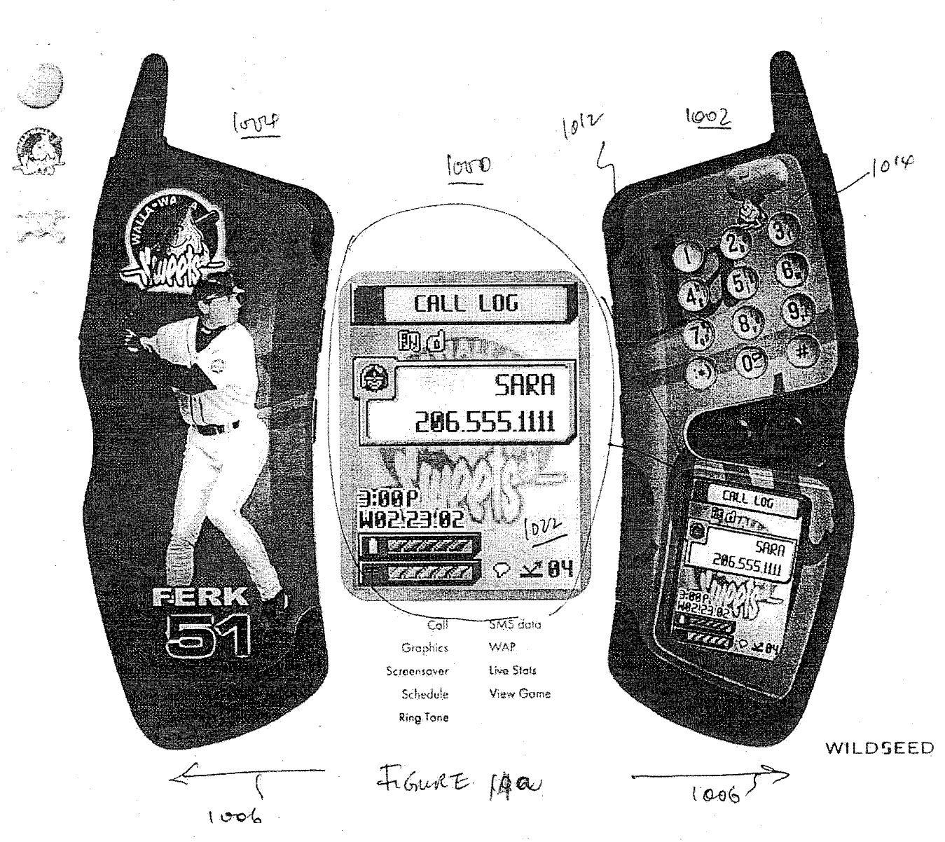

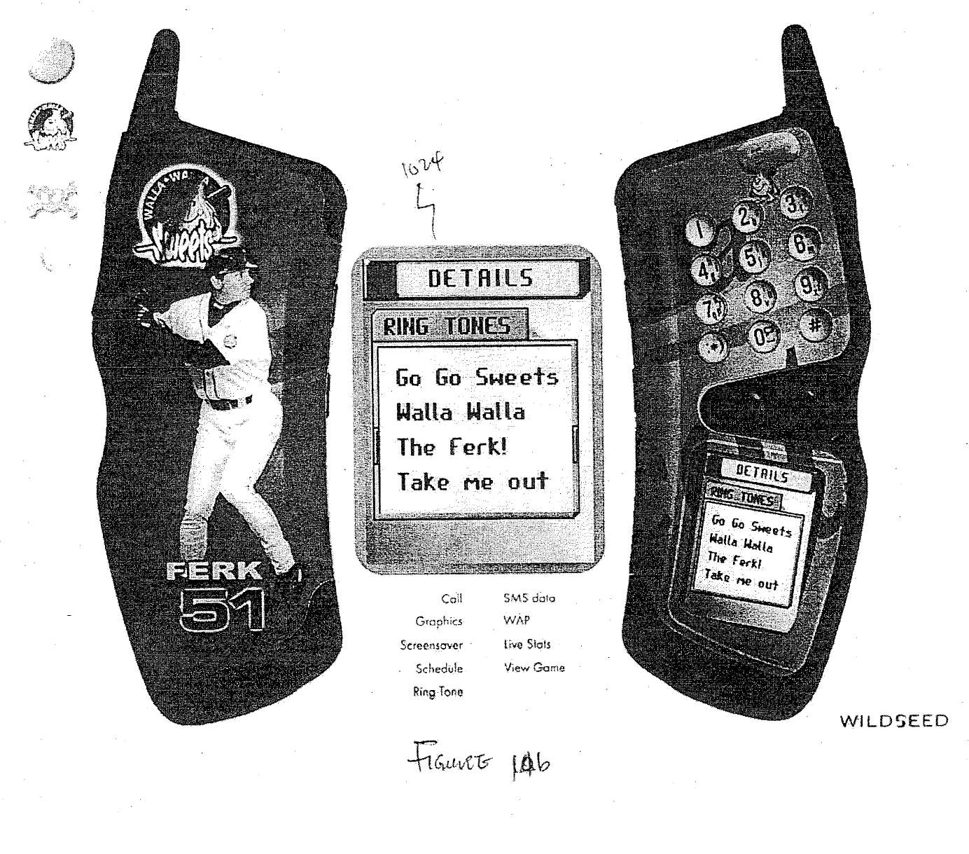

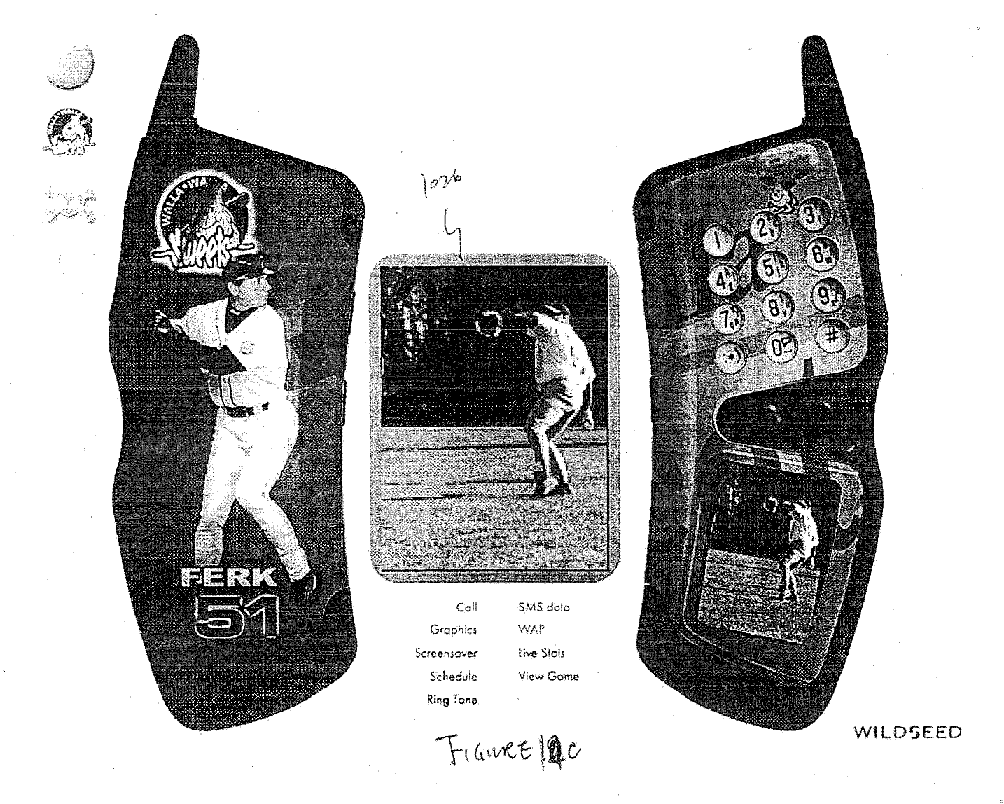

FIGS. 13a-13e illustrate an example application of the present invention, personalizing a wireless mobile phone 900 to a celebrity singer theme. Shown in FIG. 13a is a front view 902 and a back view 904 of wireless mobile phone 900 having a boomerang shaped body 912, mated with smart accessory cover 914 incorporated with the teachings of the present invention. For the embodiment, smart accessory cover 914 is substantially U-shaped, designed to snap onto body 912 in a sideway direction 906, to mate with body 912.

As illustrated and described earlier, the exterior surface of smart accessory cover 914 is decorated with graphic design to visually convey the celebrity singer theme. The celebrity singer may be any one of a number of past, present, or future famous singers, male or female, of rock n roll, country, pop, jazz, rap or classical music.

As described earlier, smart accessory cover 914 includes an electronic component (not visible) having data (or a portion thereof) that personalize the functionalities and/or behaviors of wireless mobile phones 900 to the celebrity singer theme, or location data identify where the data (or the remainder) may be obtained.

The personalization may include personalizing “wallpaper” 922 and providing ring tones using audio segments extracted from audio materials, such as songs, of the celebrity 924 (FIG. 13b) in support of the celebrity singer theme. The personalization may further include providing video and/or picture of the celebrity 926 (FIG. 13c), providing audio materials, such as songs, of the celebrity 928 (FIG. 13d), as well as providing lyrics of the provided songs 930 (FIG. 13e). One or more of the provided pictures may be used as a screensaver.

The pictures, audio and video may be in any one of a number of compressed formats. For example, in the case of pictures, the compressed format may be JPEG, GIF and so forth. Audio may be encoded as MP3 files. Video may be encoded in accordance to MPEGx. Location data to retrieve all or a portion of the personalization data may be an URL identifying the data hosting server.

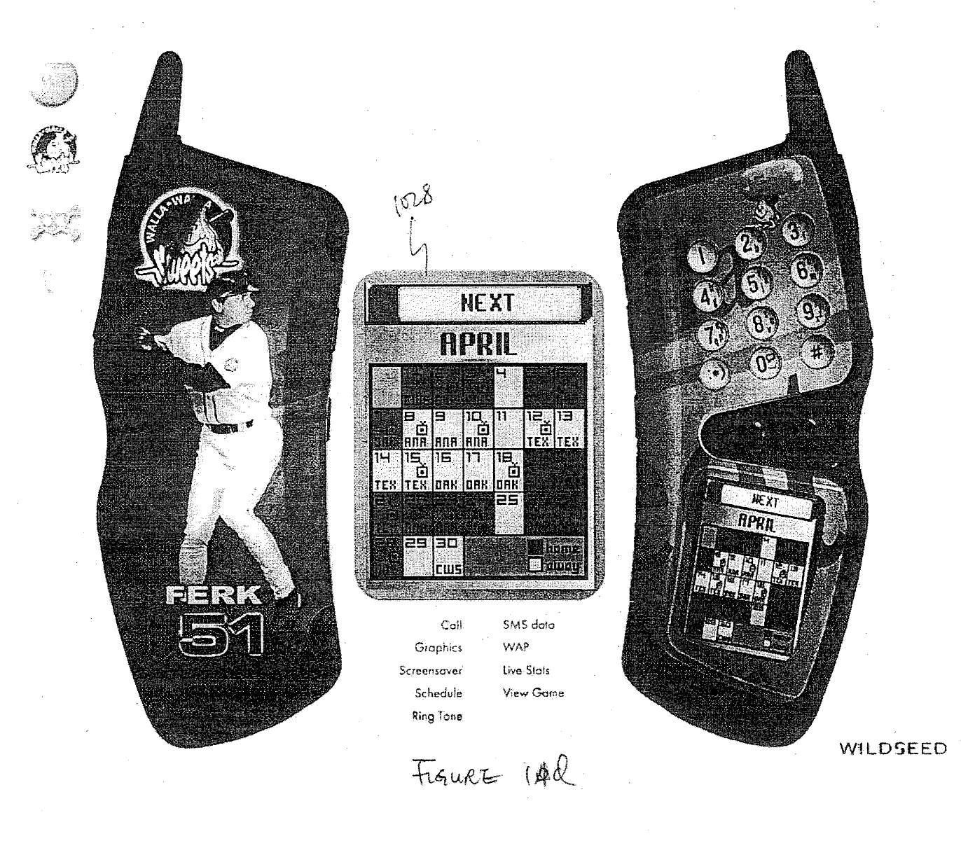

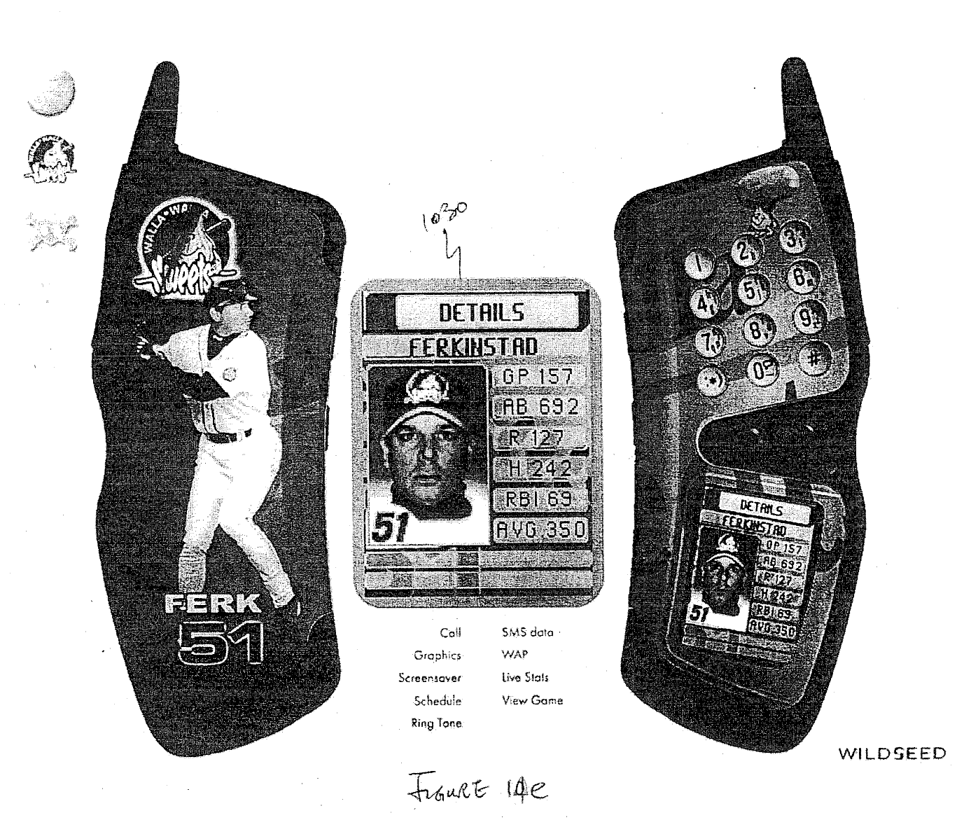

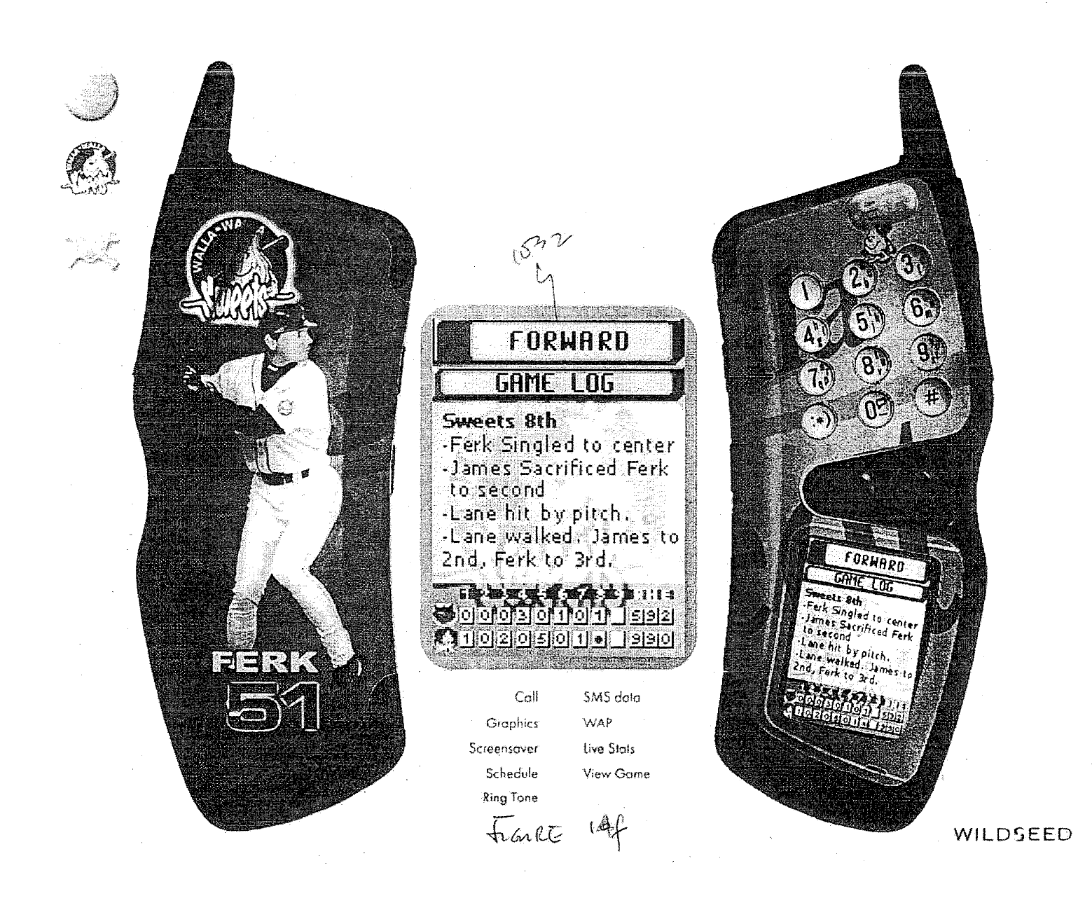

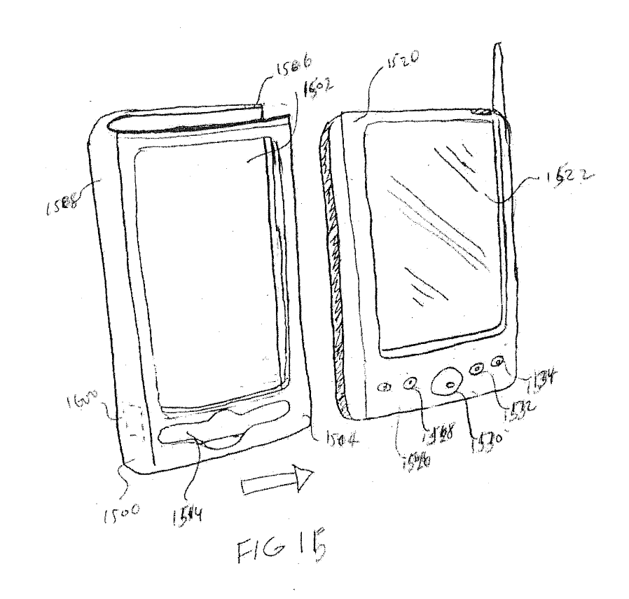

FIGS. 14a-14f illustrate another example application of the present invention, personalizing a wireless mobile phone 1000 to a celebrity sport figure theme. Shown in FIG. 14a is a front view 1002 and a back view 1004 of wireless mobile phone 1000 having a boomerang shaped body 1012, mated with smart accessory cover 1014 incorporated with the teachings of the present invention. For the embodiment, smart accessory cover 1014 is substantially U-shaped, designed to snap onto body 1012 in a sideway direction 1006, to mate with body 1012.

As illustrated and described earlier, the exterior surface of smart accessory cover 1014 is decorated with graphic design to visually convey the celebrity sport figure theme. The celebrity sport figure may be any one of a number of past, present and future famous sport figures, male or female, of the sport of baseball, basketball, football, soccer, ice hockey, figure skating, tennis, and so forth.

As described earlier, smart accessory cover 1014 includes an electronic component (not visible) having data (or a portion thereof) that personalize the functionalities and/or behaviors of wireless mobile phones 1000 to the celebrity sport figure theme, or location data identify where the data (or the remainder) may be obtained.

The personalization may include personalizing “wallpaper” 1022 and providing ring tones using audio segments extracted from audio materials, such as songs, consistent with the sport 1024 (FIG. 14b) in support of the celebrity sport figure theme. The personalization may further include providing video and/or pictures of the celebrity sport figure 1026 (FIG. 14c), providing game schedule of the celebrity sport figure's team 1028 (FIG. 14d), providing statistics of the celebrity sport figure 1030 (FIG. 14e), as well as logic to access a current and/or past game log 1032 (FIG. 14f). One or more of the provided pictures and game schedules may be used as a screensaver.

The game schedules, game log and other data of like may be retrieved from a remote server.

In various embodiments, embedded electronic component 100 may also include data to provide electronic coupons that allow a user of the wireless mobile phone to obtain discounts on purchases of items or services. The items or services may be related to the personalizing theme of the smart accessory cover, or related to the business of advertisers or sponsors of the smart accessory cover.

In yet other embodiments, embedded electronic component 100 may also include data to implement a font complementing the personalizing theme of the smart accessory cover. The font may correspond to personalizing themes, such as, but not limited to, an alien font from a science fiction series, and so forth.

Having now described the present invention in the context of personalizing mobile phones, as alluded to earlier, the present invention is so limited, and we turn now to describe the practice of the present invention in the context of personal digital assistants (PDAs), pocket PCs, and other mobile electronic devices or the like.

In addition to mobile phones, the smart accessory cover of the present invention may also be adapted to attach to other types of mobile communication devices, including PDAs, pocket PCs, and two-way wireless pagers, such as the Blackberry devices produced by the Research In Motion Corporation.

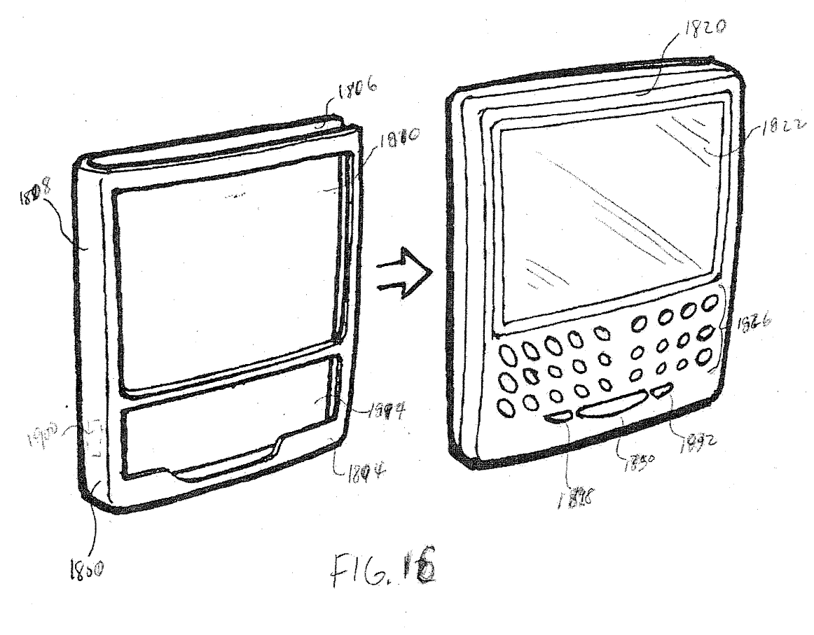

For example, an exemplary embodiment in which an smart accessory cover 1500 suitable for adorning by a PDA 1520 is shown in FIG. 15. Similar to smart accessory cover 10 or 60, smart accessory cover 1500 is not a required element to complete PDA 1520, in particular, smart accessory cover 1500 does not form part of the housing of PDA 1520.

Similar to the smart accessory cover embodiments discussed above, smart accessory cover 1500 comprises a resilient semi-rigid shell including front and back portions 1504 and 1506 coupled to a side portion 1508 wherein the shell has a substantially “U”-shaped profile.

Smart accessory cover 1500 further includes electronic component 1600 having data to personalize PDA 1620.

Additionally, for the embodiment, smart accessory cover 1500 includes an aperture 1502 through which an LCD display 1522 on PDA 1520 can be seen, and a cutout 1514 adapted to allow buttons 1526, 1528, 1530, 1532, and 1534 on PDA 1520 to pass, upon adorning the smart accessory cover. Alternatively, a respective cutout for each PDA button may be provided instead.

Another exemplary embodiment in which smart accessory cover 1800 is secured to a two-way wireless pager 1820 is shown in FIG. 16. As before, smart accessory cover 1800 comprises a resilient semi-rigid shell including front and back portions 1804 and 1806 coupled to a side portion 1808, wherein the shell has a substantially “U”-shaped profile.

Smart accessory cover 1800 further includes electronic component 1900 having data to personalize wireless pager 1820.

Further, for the embodiment, smart accessory cover 1800 further includes an aperture 1810 through which and LCD display 1822 on two-way wireless pager 1820 can be seen, and a cutout 1814 adapted to allow pager keypad buttons 1826 and input buttons 1828,1830, and 1832 on two-way wireless pager 1820 to pass upon adorning smart accessory cover 1800.

As with smart accessory covers 10 and 60, while illustrated with a substantially U-shaped embodiment, smart accessory covers 1500 and 1800 are likewise not so limited, and may take on other shapes, to be adorned by non-rectangular PDA and pagers.

Accordingly, a smart accessory cover with embedded personality for an electronic device having capabilities to facilitate easy and user-friendly acquisition of personalization of the electronic device has been described.

While the invention has been described in terms of the above-illustrated embodiments, one skilled in the art will recognize that the invention is not limited to the embodiments described. The invention can be practiced with modification and alteration within the spirit and scope of the appended claims.

For example, the present invention may be practiced with options to allow a user to accept or reject all or a portion of the additional functionalities and/or content to be added to the base electronic device, as result of the engagement of the “smart” accessory cove.

Another example is in some embodiments, in lieu of the employment of an electronic component, a bar code or a magnetic stripe having certain identification information be used instead to “couple” to the base electronic device (having complementary bar code or magnetic stripe “reader” capability), the type and/or location of the additional functionalities and/or contents.

Another example is the inclusion of certain anti-piracy features, such as upon installation of the added functionalities and/or contents, the same combination of smart accessory cover and base electronic device is required for the installed additional functionalities and/or content to be available and/or useable.

Thus, the description is to be regarded as illustrative instead of restrictive on the invention.

What is claimed is:

1. An smart accessory cover for personalizing a mobile electronic apparatus comprising:
a cover body, not an element required to complete the mobile electronic apparatus, to be adorned by the mobile electronic apparatus, covering at least partially a plurality of exterior surfaces of a body of the apparatus, with the exterior surfaces being disposed on different geometric planes;
graphic design disposed on one or more exterior surfaces of the cover body to convey a theme; and
an electronic component disposed in an inside surface of the cover body, and having at least a selected one of data and location to retrieve said data, said data personalizing a functionality of the mobile electronic apparatus in support of the theme.

2. The accessory cover of claim 1, wherein the cover body is substantially U-shaped, designed to snap onto said body of the mobile electronic apparatus from a sideway direction.

3. The accessory cover of claim 1, wherein the theme is a celebrity singer theme.

4. The accessory cover of claim 3, wherein the celebrity singer theme comprise a singer of a music family selected from a music family group comprising rock n roll, country, pop, jazz, rap and classical.

5. The accessory cover of claim 3, wherein the data provide a ring tone comprising audio segments extracted from songs of the celebrity singer theme.

6. The accessory cover of claim 3, wherein the data provide at least a selected one of video/picture and audio materials in support of the celebrity singer theme.

7. The accessory cover of claim 3, wherein the data provide lyrics of songs in support of the celebrity singer theme.

8. The accessory cover of claim 1, wherein the theme is a celebrity sport figure theme.

9. The cover of claim 8, wherein the celebrity sport figure theme comprise a sport figure of a sport selected from a sport group comprising baseball, basketball, football, soccer, ice hockey, tennis, and figure skating.

10. The accessory cover of claim 8, wherein the data provide a ring tone comprising audio segments extracted from songs consistent with the celebrity sport figure theme.

11. The accessory cover of claim 8, wherein the data provide at least a selected one of video/picture in support of the celebrity sport figure theme.

12. The accessory cover of claim 8, wherein the data provide a game schedule in support of the celebrity sport figure theme.

13. The accessory cover of claim 8, wherein the data provide logic to access a game log in support of the celebrity sport figure theme.

14. The accessory cover of claim 1, wherein the cover body comprises a resilient semi-rigid shell including a front face and back face commonly connected to a side portion to wrap around a portion of a front, back and side of the mobile electronic apparatus upon adornment by the mobile electronic apparatus.

15. The accessory cover of claim 1, wherein the cover body is designed to be adorned by the mobile electronic apparatus without the employment of fasteners.

16. The accessory cover of claim 1, wherein the accessory cover further comprise a membrane including a plurality of dumb buttons to facilitate a user to activate corresponding keys of a keypad of the mobile electronic device.

17. The accessory cover of claim 1, further comprising a plurality of notches defined in at least one of a front face and a back face of the accessory cover, to assist in securing the accessory cover to the adorning mobile electronic apparatus.

18. The accessory cover of claim 1, further comprising a plurality of latches defined in at least one of a front face and a back face of the accessory cover, to assist in securing the accessory cover to the adorning mobile electronic apparatus.

19. The accessory cover of claim 1, further comprising a plurality of inwardly extending protrusions defined in at least one of a front face and a back face of the accessory cover, to assist in securing the accessory cover to the adorning mobile electronic apparatus.

20. The accessory cover of claim 1, wherein the electronic component comprises a selected of a EEPROM and compact flash.

21. The accessory cover of claim 1, wherein the electronic component comprises a processor.

22. The accessory cover of claim 1, wherein the apparatus comprises a selected one of a wireless mobile phone, a personal digital assistant and a wireless text messaging apparatus.
